(19) United States
(12) Patent Application Publication
(10) Pub. No.: US 2015/0344698 A1
(43) Pub. Date: Dec. 3, 2015

(54) ADHESION PRIMER FOR GLASS AND CERAMICS

(71) Applicant: Corning Incorporated, Corning, NY (US)

(72) Inventor: Paul John Shustack, Elmira, NY (US)

(21) Appl. No.: 14/715,982

(22) Filed: May 19, 2015

Related U.S. Application Data
(60) Provisional application No. 62/006,934, filed on Jun. 3, 2014.

(51) Int. Cl. C09D 5/00; C04B 41/89; C03C 17/34; C04B 41/83; C09D 163/00; C09D 181/04

(52) U.S. Cl. CPC C09D 5/002; C09D 163/00; C09D 181/04; C03C 17/3405; C04B 41/83; C04B 41/89

(57) ABSTRACT

A primer composition that provides a primer layer that improves adhesion between a coating and a substrate. The primer composition includes an adhesion promoter and a catalyst. The adhesion promoter includes a functional group that reacts with the substrate and a functional group that reacts with the coating or a component of the coating composition used to form the coating. Functional groups that react with the substrate include hydroxyl groups and alkoxy groups. The coating or components of the coating composition may include thiol or episulfide groups. Functional groups of the adhesion promoter that react with the coating or coating composition include epoxy groups and episulfide groups. The coating may form from a reaction between the coating composition and the primer layer and/or between components of the coating composition. The reaction that forms the coating may be catalyzed by a catalyst in the primer layer that was included in the primer composition.

This application claims the benefit of priority under 35 U.S.C. §119 of U.S. Provisional Application Ser. No. 62/006,934 filed on Jun. 3, 2014 the content of which is relied upon and incorporated herein by reference in its entirety.

### FIELD

This description pertains to coated glass and ceramic articles and methods for coating glass and ceramic articles. More specifically, this description pertains to a primer for glass and ceramic articles that improves the adhesion of coatings to the glass and ceramics. Most specifically, this description pertains to a primer composition that provides a primer layer on the surface of glasses and ceramics that improves adhesion sulphur-based polymer coatings to the glasses and ceramics.

### BACKGROUND

It is frequently desirable to modify the properties of glasses and ceramics by applying coatings to the surface. Coatings can provide a passive protective function to prevent scratches or damage to the underlying glass or ceramic substrate and can also be used to alter active properties such as electrical, optical, chemical, and magnetic properties. The most common coatings are polymers, which may be applied as laminates to the surface or formed in situ on the surface. In situ methods of forming coatings on glass or ceramic substrates include solution deposition processes (e.g. film casting, sol-gel), vapor deposition (e.g. CVD, evaporation), and energetic beam or ion deposition (e.g. plasma processes, sputtering, electron beam techniques).

Lack of adhesion is a common problem that arises in the coating of glass and ceramic substrates. In order to realize the beneficial effects of the coating, the coating must adhere well to the substrate and remain durable over time. The coating, for example, must not delaminate or peel from the substrate. Adhesion promoters are commonly used to improve adhesion of coatings to glass or ceramic substrates. Adhesion promoters are compounds that chemically link the coating to the substrate. Adhesion promoters are typically multifunctional and include one functional group intended to form a bond with the substrate and a second functional group intended to form a bond with the coating. The surface of the substrate may include reactive groups or sites and the adhesion promoter can be designed to incorporate a functional group that reacts with such reactive groups or sites. Similarly, the coating, or a component or precursor thereof, may include a reactive functional group and the adhesion promoter may be designed to include a functional group that reacts with the reactive functional group of the coating.

Many glass and ceramic substrates include reactive surface hydroxyl groups. Adhesion promoters with acid or hydroxyl groups can react with surface hydroxyl groups through condensation reactions to form a bond that links the adhesion promoter to the substrate. The adhesion promoter further includes a second functional group for reaction with a coating to complete the link that chemically attaches the coating to the glass. To accommodate the wide range of coatings, adhesion promoters that include a variety of different functional groups are available. Representative functional groups of adhesion promoters designed to react with coatings include amine groups, acid groups, isocyanate groups, hydroxyl groups, and ethylenically unsaturated groups. Important classes of commercially available adhesion promoters include organofunctional silanes, organofunctional acids, organofunctional phosphates, and organofunctional metallates (e.g. titanates and zirconates).

For customized applications, it is often desirable to adhere a specialty coating to a glass or ceramic substrate. Frequently, the known adhesion promoters are incompatible with specialty coatings. There is accordingly a need to design new adhesion promoters.

### SUMMARY

The present description provides a primer composition for adhering coatings to substrates, articles that contain the coated substrates, and methods for forming articles with coatings adhered to substrates with primer layers formed from the primer composition.

The primer composition includes an adhesion promoter and a catalyst. The adhesion promoter includes one or more compounds, where at least one compound includes a functional group capable of forming a chemical bond with a substrate and at least one compound includes a functional group capable of forming a chemical bond with the coating. In one embodiment, the adhesion promoter includes a compound with two or more functional groups, where one functional group is capable of forming a bond with a substrate and another functional group is capable of forming a bond with a coating.

The adhesion promoter may be a compound of the form:

(F₂)_{z}(R₂)_{y}M₁(F₁)ₓ

where F₁ is a functional group that is capable of forming a bond with a substrate, F₂ is a functional group that is capable of forming a bond with a coating or a component of a coating composition, R₂ is an organic group, M₁ is a central atom having a coordination number equal to x+y+z, x≧1, y≧0, and z≧1. M₁ may be Si or a transition metal. R₂ may be an alkyl group. F₁ may be a hydroxyl group or an alkoxy group. F₂ may be an epoxy group or an episulfide group.

The adhesion promoter may be a compound of the form:

(F₂—R₃)_{z}(R₂)_{y}M₁(R₁—F₁)ₓ

where F₁ is a functional group that is capable of forming a bond with a substrate; F₂ is a functional group that is capable of forming a bond with a coating or a component of a coating composition; R₁, R₂, and R₃ are organic groups that may be the same or different, M₁ is a central atom having a coordination number equal to x+y+z, x≧1, y≧0, and z≧1. M₁ may be Si or a transition metal. R₁, R₂, and R₃ may be alkyl groups. F₁ may be a hydroxyl group or an alkoxy group. F₂ may be an epoxy group or an episulfide group.

The primer composition may further include a catalyst. In one embodiment, the catalyst promotes a reaction between the adhesion promoter and the substrate. In another embodiment, the catalyst promotes a reaction between the adhesion promoter and the coating or a component of the coating composition used to form the coating. The catalyst may be a base.

The articles include a substrate, a primer layer, and a coating. In one embodiment, the substrate is a glass or glass-containing substrate. In another embodiment, the substrate is a ceramic or ceramic-containing substrate. Representative substrates include silica glass, silica glass that includes two or more network formers, silica glass that includes one or more network modifiers, and metal oxide ceramics.

The primer layer is disposed between the substrate and the coating and forms a chemical link between the substrate and coating. In one embodiment, the primer layer includes chemical bonds with the substrate and the coating. The chemical bond with the substrate may include an oxide linkage of the form M₂-O-M₁, where M₂ is an element of the substrate and M₁ is an element of the primer layer. The chemical bond with the coating may include a linkage of the form

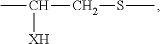

where, in one embodiment, the sulfur of the linkage originates in the coating and the oxygen of the linkage originates in the primer layer. The element X may be O or S.

In one embodiment, the coating is a polymer. The polymer may contain sulfur.

In one embodiment, the coating is a copolymer of two or more monomers. In one embodiment, one of the monomers contains sulfur. In another embodiment, two of the monomers contain sulfur. In still another embodiment, the sulfur present in one or more monomers is present in a reactive functional group. In one embodiment, the reactive functional group is a thiol group. In another embodiment, the reactive functional group is an episulfide group. The one or more monomers may include a monomer with a thiol group and a monomer with an episulfide group. The one or more monomers may each include two or more functional groups. In one embodiment, the one or more monomers include a monomer with two thiol groups, or two episulfide groups, or one thiol group and one episulfide group.

The coating may have a refractive index greater than or equal to 1.6. The substrate may have a refractive index greater than or equal to 1.6. The coating may have a refractive index that matches the refractive index of the substrate to within ±5%, or ±3%, or ±1%.

The present description includes methods of making articles. The methods include applying a primer composition to a substrate, forming a primer layer from the primer composition, applying a coating composition to the primer layer, and forming a coating from the coating composition.

Representative methods for applying the primer composition to the substrate include dipping, spraying, brushing, pouring, and spin coating. The primer composition includes an adhesion promoter. The primer layer forms from the primer composition through reaction of a functional group of the adhesion promoter with the substrate. The reaction may occur at room temperature. Alternatively, the reaction may occur at elevated temperature. In one embodiment, the primer composition includes a catalyst and the catalyst is retained in the primer layer.

Representative methods for applying the coating composition to the substrate include dipping, spraying, brushing, pouring, and spin coating. In one embodiment, the coating forms from a reaction between the coating composition and the primer layer. In another embodiment, the coating forms from a reaction between two or more components of the coating composition. In a further embodiment, the coating forms from a reaction between a component of the coating composition and the primer layer and a reaction between two or more components of the coating composition.

In one embodiment, the primer layer includes a catalyst and the catalyst promotes a reaction between the primary layer and coating composition. In another embodiment, the primer layer includes a catalyst and the catalyst promotes a reaction between two or more components of the coating composition. In one embodiment, the catalysed reaction between two or more components of the coating composition is a polymerization reaction.

The present description extends to:

An article comprising:

a substrate, said substrate comprising an element M₂;

a primer layer on said substrate, said primer layer comprising an element M₁ and an element X, said primer layer being chemically bonded to said substrate through a first chemical linkage, said first chemical linkage comprising said element M₁, said element M₂, and oxygen, said first chemical linkage having the form M₁-O-M₂; and

a coating comprising sulfur on said primer layer, said coating being chemically bonded to said primer layer through a second chemical linkage, said second chemical linkage comprising said sulfur and said element X, said second chemical linkage having the form

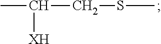

wherein said element X is O or S.

The present description extends to:

A primer composition comprising:

an adhesion promoter, said adhesion promoter including a central atom, a first functional group chemically linked to said central atom, and a second functional group chemically linked to said central atom; and a catalyst.

The present description extends to:

18. A primer composition comprising:

an adhesion promoter, said adhesion promoter including a central atom, a first functional group chemically linked to said central atom, and a second functional group chemically linked to said central atom; and

a catalyst;

wherein said central atom is Si or a transition metal, said first functional group is a hydroxyl group, said second functional group is an epoxy or episulfide group, and said catalyst is a base.

The present description extends to:

A method of coating comprising:

forming a primer layer on a substrate, said substrate comprising an element M₂ and oxygen, said forming primer layer comprising applying a primer composition to said substrate, said primer composition comprising an adhesion promoter, said adhesion promoter having a central element M₁, a first functional group, and a second functional group, said first functional group reacting with said substrate to form a chemical link between said adhesion promoter and said substrate; and

forming a coating on said primer layer, said forming coating comprising applying a coating composition to said primer layer, said coating composition comprising a first functional group containing sulfur, said first functional group containing sulfur reacting with said second functional group of said adhesion promoter to form a chemical link between said primer layer and said coating.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings are illustrative of selected aspects of the present description, and together with the specification serve to explain principles and operation of methods, products, and compositions embraced by the present description. Features shown in the drawing are illustrative of selected embodiments of the present description and are not necessarily depicted in proper scale.

### BRIEF DESCRIPTION OF THE DRAWINGS

While the specification concludes with claims particularly pointing out and distinctly claiming the subject matter of the description, it is believed that the description will be better understood from the following specification when taken in conjunction with the accompanying drawings, wherein:

FIG. 1 depicts formation of a chemical bond between an adhesion promoter and a substrate.

FIG. 2 depicts an epoxy-functionalized substrate surface produced by multiple reactions of the type shown in FIG. 1.

FIG. 3 illustrates reaction of a thiol group with an episulfide group.

FIG. 4 illustrates reaction of a bifunctional thiol monomer with an epoxy-functionalized primer layer.

FIG. 5 depicts an article that includes a substrate, a primer layer on the substrate, and a coating on the primer layer.

### DETAILED DESCRIPTION

The present description provides a primer composition for improving adhesion of coating layers to substrates. The primer composition provides a primer layer that improves the strength of coupling of the coating layer to the substrate and leads to stronger adhesion of the coating to the substrate. The present description also provides articles that contain a primer layer formed from the primer composition. The articles include a substrate, a primer layer on the substrate, and a coating on the primer layer. The primer layer improves adhesion by providing a chemical link between the substrate and the coating. The present description further provides a method of making articles that includes applying the primer composition to a substrate, forming a primer layer from the primer composition, applying a coating composition to the primer layer, and forming a coating from the coating composition.

The substrate is a solid material with a surface for receiving a coating. In one embodiment, the substrate is a glass. Representative glasses include silica glasses and silica glasses doped with one or more of alkali elements, alkaline earth elements, boron, aluminum, phosphorous, halides, transition metals, and lanthanides. The doping element(s) may be network formers or network modifiers. The substrate may also be an ion-exchanged glass. In another embodiment, the substrate is a ceramic. Representative ceramics include metal oxide and mixed metal oxide ceramics. In still another embodiment, the substrate includes surface hydroxyl groups. The substrate may be a high refractive index material. The refractive index of the substrate at a wavelength of 589 nm may be at least 1.6, or at least 1.8, or at least 2.0, or at least 2.2, or at least 2.4.

The substrate may include reactive sites or functional groups. The reactive functional groups may include hydroxyl groups. The reactive sites or functional groups may be present on the surface of the substrate.

The primer composition includes an adhesion promoter and a catalyst. The adhesion promoter includes one or more compounds, where at least one compound includes a functional group that reacts with the substrate to form a chemical bond and at least one compound includes a functional group that reacts with the coating or a component of the coating composition to form a chemical bond. In one embodiment, the adhesion promoter includes a compound with two or more functional groups, where one functional group reacts with the substrate to form a chemical bond with and another functional group reacts with the coating or a component of the coating composition to form a chemical bond. In another embodiment, the adhesion promoter includes a first compound with a functional group that reacts with the substrate and a second compound with a functional group that reacts with the coating, where the first and second compounds further react with each other to form a continuous chemical link between the coating and the substrate.

The adhesion promoter may be a compound of the formula (I):

(F₂)_{z}(R₂)_{y}M₁(F₁)ₓ (I)

where F₁ is a functional group that reacts to form a bond with a substrate; F₂ is a functional group that reacts to form a bond with a coating or a component of a coating composition; R₂ is an organic group, each instance of which may be the same or different; M₁ is a central atom having a coordination number equal to x+y+z, x≧1; y≧0; and z≧1. In one embodiment, M₁ is Si or a transition metal. R₂ may be an alkyl group. R₂ may include an alkylene group, ether group, ester group, keto group, amide group, or urethane group. F₁ may be a hydroxyl group or an alkoxy group. When F₁ is an alkoxy group, the reaction of F₁ may include hydrolysis of the alkoxy group to form a hydroxyl group and further reaction of the hydroxyl group with the substrate. F₂ may be an epoxy group or an episulfide group. In one embodiment, x=1 and z=1. In another embodiment, x=1, y=2, and z=1.

The adhesion promoter may be a compound of the formula (II):

(F₂)_{z}(R₂)_{y}M₁(R₁—F₁)ₓ (II)

where F₁ is a functional group that reacts to form a bond with a substrate; F₂ is a functional group that reacts to form a bond with a coating or a component of a coating composition; R₁ and R₂ are organic groups, each instance of which may be the same or different; M₁ is a central atom having a coordination number equal to x+y+z; x≧1; y≧0; and z≧1. In one embodiment, M₁ is Si or a transition metal. R₁ and R₂ may include alkylene groups, ether groups, ester groups, keto groups, amide groups, or urethane groups. R₂ may be an alkyl group. F₁ may be a hydroxyl group or an alkoxy group. When F₁ is an alkoxy group, the reaction of F₁ may include hydrolysis of the alkoxy group to form a hydroxyl group and further reaction of the hydroxyl group with the substrate. F₂ may be an epoxy group or an episulfide group. In one embodiment, x=1 and z=1. In another embodiment, x=1, y=2, and z=1.

The adhesion promoter may be a compound of the formula (III):

(F₂—R₃)_{z}(R₂)_{y}M₁(F₁)ₓ (III)

where F₁ is a functional group that reacts to form a bond with a substrate; F₂ is a functional group that reacts to form a bond with a coating or a component of a coating composition; R₂ and R₃ are organic group, each instance of which may be the same or different; M₁ is a central atom having a coordination number equal to x+y+z; x≧1; y≧0; and z≧1. In one embodiment, M₁ is Si or a transition metal. R₂ and R₃ may include alkylene groups, ether groups, ester groups, keto groups, amide groups, or urethane groups. R₂ may be an alkyl group. F₁ may be a hydroxyl group or an alkoxy group. When F₁ is an alkoxy group, the reaction of F₁ may include hydrolysis of the alkoxy group to form a hydroxyl group and further reaction of the hydroxyl group with the substrate. F₂ may be an epoxy group or an episulfide group. In one embodiment, x=1 and z=1. In another embodiment, x=1, y=2, and z=1.

The adhesion promoter may be a compound of the formula (IV):

(F₂—R₃)_{z}(R₂)_{y}M₁(R₁—F₁)ₓ (IV)

where F₁ is a functional group that reacts to form a bond with a substrate; F₂ is a functional group that reacts to form a bond with a coating or a component of a coating composition; R₁, R₂, and R₃ are organic groups, each instance of which may be the same or different; M₁ is a central atom having a coordination number equal to x+y+z; x≧1; y≧0; and z≧1. In one embodiment, M₁ is Si or a transition metal. R₁, R₂, and R₃ may include alkylene groups, ether groups, ester groups, keto groups, amide groups, or urethane groups. R₂ may be an alkyl group. F₁ may be a hydroxyl group or an alkoxy group. When F₁ is an alkoxy group, the reaction of F₁ may include hydrolysis of the alkoxy group to form a hydroxyl group and further reaction of the hydroxyl group with the substrate. F₂ may be an epoxy group or an episulfide group. In one embodiment, x=1 and z=1. In another embodiment, x=1, y=2, and z=1.

In formulas (I)-(IV), the functional groups F₁ and F₂ are chemically linked to each other. Each of functional groups F₁ and F₂ is also chemically linked to element M₁. As used herein, two chemical entities (e.g. elements or functional groups) are chemically linked if they are directly bonded to each other or if a continuous series of chemical bonds is present between them. In formula (III), for example, functional group F₁ is chemically linked to element M₁ because it is directly bonded to it. Similarly, in formula (III) functional group F₂ is chemically linked to element M₁ through the group R₃. The group R₃ may be referred to as a chemical link or chemical linkage that bonds functional group F₂ to element M₁.

One class of adhesion promoters is epoxy-functional silanols having the general formula (V):

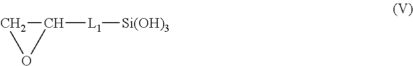

where L₁ is an organic group, such as an alkylene group, ether group, ester group, keto group, amide group, or urethane group. Other embodiments of adhesion promoters include variations of formula (V) in which Si is replaced with Ti or Zr and/or the oxygen of the epoxy functional group is replaced with sulfur. The functional group obtained by replacing the oxygen of the epoxy functional group is referred to herein as an episulfide group or episulfide functional group.

Another class of adhesion promoters is epoxy-functional silicon alkoxides having the general formula (VI):

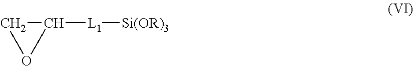

where L₁ is an organic group, such as an alkylene group, ether group, ester group, keto group, amide group, or urethane group. Other embodiments of adhesion promoters include variations of formula (VI) in which Si is replaced with Ti or Zr and/or the oxygen of the epoxy functional group is replaced with sulfur. Compounds of formula (VI) and the indicated variations thereof may undergo hydrolysis of the alkoxy (OR) groups in the presence of water to form hydroxyl groups.

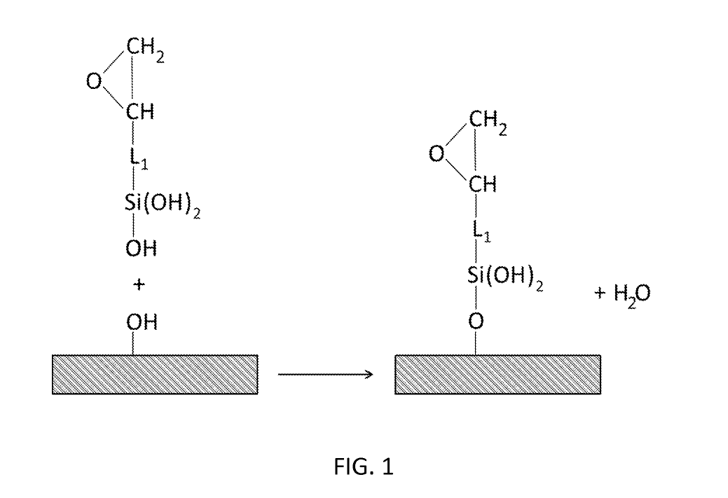

FIG. 1 illustrates formation of a chemical bond between an adhesion promoter of the type shown in formula (V) and a substrate. The substrate includes a reactive surface hydroxyl group. The hydroxyl group of the adhesion promoter reacts with the surface hydroxyl group of the substrate to release water as a byproduct and form a bond that chemically links the adhesion promoter to the substrate. If the substrate is a silica glass, the surface hydroxyl group is bonded to a silicon atom and the chemical link is a —Si—O—Si— link, where one silicon originates from the adhesion promoter and the other silicon originates from the substrate. The epoxy group of the linked adhesion promoter remains available for reaction. As described more fully hereinbelow, the epoxy group may react with a coating or a component of a coating composition to form a bond that links a coating to the substrate through the adhesion promoter.

Although FIG. 1 illustrates a chemical link of the adhesion promoter to the substrate through a single hydroxyl group of the adhesion promoter, it is understood that multiple hydroxyl groups of the adhesion promoter may react with reactive surface hydroxyl groups of the substrate to form multiple chemical links between the adhesion promoter and substrate. Analogous reactions occur when Si is replaced by Ti, Zr or other central atom, or when the hydroxyl group of the adhesion promoter is replaced by an alkoxy group or other functional group capable of reacting with a reactive hydroxyl or other group of the substrate. When the reactive functional group of the adhesion promoter is an alkoxy group, the alkoxy group can react with a substrate surface hydroxyl group to form a link to the substrate as shown in FIG. 1 and release an alcohol as a byproduct instead of water. Alternatively, alkoxy group may hydrolyze to form a hydroxyl group and react as shown in FIG. 1.

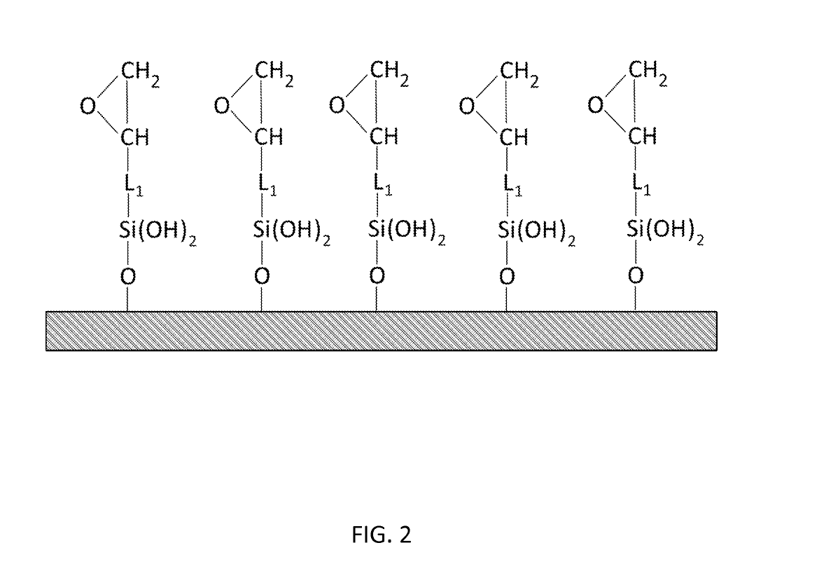

FIG. 1 illustrates formation of a chemical bond between a single adhesion promoter molecule and a single reactive functional group of the substrate. In the general case, multiple molecules of adhesion promoter will react with multiple reactive functional groups of the substrate to form a series of chemically linked promoter molecules on the surface of the substrate. The product of the reaction is a reactive group functionalized substrate surface. FIG. 2, for example, shows an epoxy-functionalized substrate surface that is obtained through multiple reactions of the type shown in FIG. 1.

In one embodiment, the chemical link that bonds the adhesion promoter to the substrate is a link of the type -M₁-O-M₂- where M₁ originates from the adhesion promoter (e.g. Si, Ti, Zr) and M₂ originates from the substrate (e.g. Si of the substrate is a silica glass, a transition metal if the substrate is a transition metal oxide ceramic).

In addition to an adhesion promoter, the primer composition may include a catalyst. In one embodiment, the catalyst catalyzes the reaction of a functional group of the adhesion promoter with a reactive functional group of the substrate to facilitate formation of a chemical link between the adhesion promoter and the substrate. In another embodiment, the catalyst catalyzes the reaction of a functional group of the adhesion promoter with a reactive functional group of the coating or a component in the coating composition to facilitate formation of a chemical link between the adhesion promoter and the coating or a component of the coating composition. In still another embodiment, the catalyst catalyzes reactions of two or more functional groups of the adhesion promoter with two or more functional groups of the substrate, two or more functional groups of a coating, or two or more functional groups of one or more components of a coating composition. The catalyst may, for example, catalyze a reaction of one functional group of the adhesion promoter with a functional group of the substrate to promote formation of a chemical link between the adhesion promoter and the substrate as well as a reaction of another functional group of the adhesion promoter with a functional group of the coating or a component of the coating composition. In a further embodiment, the catalyst may catalyze a reaction between two or more components of a coating composition to promote reaction of the components to facilitate formation of a coating.

In one embodiment, the catalyst is a base. Representative bases include organic bases such as bicyclic amidines, bicyclic amines, guanidines, phosphazines, and tertiary amines. Examples of such amines are 1,8-Diazabicyclo[5.4.0]undec-7-ene (DBU), 1,5-Diazabicyclo[4.3.0]non-5-ene (DBN), 1,4-Diazabicyclo[2.2.2]octane (DABCO), 7-methyl-1,5,7-triazabicyclo[4.4.0]dec-5-ene (MTBD), 1,5,7-triazabicyclo[4.4.0]dec-5-ene (TBD), tetramethylguanidine (TMG), N-methylmorpholine, N-ethylmorpholine, dimethylpiperazine, N,N-Dimethylcyclohexylamine (DMCHA), pentamethyldiethylenetriamine (PMDETA), tetramethylbis(aminoethyl)ether (ZF-20), DMDGA™ N,N-dimethyl-2(2-aminoethoxy)ethanol (ZR-70), pentamethyldipropylenetriamine (ZR-40), tetramethyldipropylenetriamine (ZR-50B), benzyldimethylamine (BDMA).

Mechanistically, a base catalyst may act to deprotonate a functional group with a labile hydrogen. A functional group with a labile hydrogen may be referred to herein as a hydrogen-donating group. Hydrogen-donating groups include acid groups, alcohol groups and amines. Deprotonation of a hydrogen-donating group creates a negative charge at the site of deprotonation, which promotes nucleophilic reactions of the functional group by making it a stronger nucleophile. In the reaction shown in FIG. 1, for example, a base may deprotonate a hydroxyl group of the adhesion promoter to provide a negatively charged oxygen center that reacts efficiently in a nucleophilic reaction with the silicon atom to which the surface hydroxyl is bonded. The product of the nucleophilic reaction is a chemical link (—Si—O—Si—) between the adhesion promoter and the substrate and release of a hydroxyl group from the substrate (which can combine with the liberated proton to form the water byproduct).

The primer composition is applied to the substrate and reaction of the adhesion promoter of the primer composition with the substrate occurs. Representative methods for applying the primer composition to the substrate include dipping, spraying, brushing, pouring, and spin coating. The product of the reaction between the primer composition and substrate is a primer layer. The primer layer is distinguished from the primer composition in that the primer layer includes chemical bonds between the adhesion promoter and the substrate.

FIG. 2 illustrates an epoxy-functionalized primer layer. The epoxy-functionalized primer layer includes adhesion promoter molecules that are chemically bonded to the substrate and unreacted epoxy functional groups that are available for further reaction with a coating or component of a coating composition as described more fully hereinbelow. The reaction of the primer composition to form the primer layer may occur at room temperature, or at elevated temperature. In embodiments in which the primer composition includes a catalyst, the catalyst may or may not catalyze formation of the primer layer from the primer composition. Upon conclusion of the reaction to form the primer layer, unreacted catalyst is retained in the primer layer; that is, the catalyst is incorporated in the primer layer in an unreacted form. As described more fully hereinbelow, unreacted catalyst in the primer layer may catalyze reactions between the primer layer and a coating or one or more components of a coating composition. The unreacted catalyst retained in the primer layer may also catalyze reactions between two or more components of a coating composition.

The primer composition may include an adhesion promoter and a solvent or an adhesion promoter, a catalyst, and a solvent. The solvent may be any volatile organic liquid. Exemplary solvents include alcohols, ethanol, ketones, esters, ethers, and aromatics like toluene, xylene, mesitylene. The concentration of adhesion promoter in the primer composition may be in the range from 0.10 wt % to 10 wt %, or in the range from 0.15 wt % to 9 wt %, or in the range from 0.20 wt % to 8 wt %. The concentration of base in the primer composition may be in the range from 0.001 wt % to 0.3 wt %, or in the range from 0.002 wt % to 0.2 wt %, or in the range from 0.005 wt % to 0.1 wt %. The primer composition may also include a non-protic amine. As used herein, a non-protic amine is an amine in which the central nitrogen atom is not directly bonded to hydrogen. Examples of non-protic amines include tertiary amines and bis[2-(dimethylamino)ethyl]ether. In one embodiment, the primer composition includes a bicyclic amidine and a tertiaryamine. In another embodiment, the primer composition includes DBU (1,8-Diazabicyclo[5.4.0]undec-7-ene) and bis[2-(dimethylamino)ethyl]ether.

The coating is a solid material positioned on the primer layer. In one embodiment, the purpose of the coating is to protect the substrate from mechanical damage. If the substrate is an optical element or a transparent window, it may be desirable for the refractive index of the coating to closely match the refractive index of the substrate. The refractive index of the coating at a wavelength of 589 nm may be at least 1.6, or at least 1.8, or at least 2.0, or at least 2.2, or at least 2.4. The coating may have a refractive index that matches the refractive index of the substrate to within ±5%, or ±3%, or ±1%. If the substrate is a glass with a refractive index of 2.0, for example, the refractive index of the coating may be 2.0±0.10, or 2.0±0.06, or 2.0±0.02.

In one embodiment, the coating is applied to the primer layer as a laminate and a chemical bond forms between a reactive functional group of the laminate and a functional group of the primer layer.

In another embodiment, a coating is formed from a coating composition that is applied to the primer layer. The coating composition includes two or more components that react to form a coating. One or more of the components of the coating composition may also react with the primer layer. A component of the coating composition that reacts with the primer layer may also react with other components of the coating composition and become an integral part of the coating. In this way, a chemical bond forms between the primer layer and the coating.

Representative methods for applying the coating composition to the primer layer include dipping, spraying, brushing, pouring, and spin coating.

In one embodiment, the coating is a polymer and the coating composition includes one or more monomers that react to form the polymer. In another embodiment, the coating is a copolymer of two or more monomers. The reaction of the one or more monomers to form a polymer coating may be spontaneous or may be stimulated by the addition of thermal energy or electromagnetic energy. In one embodiment, the coating is a polymer formed by photocuring one or more monomers and the coating composition includes a photosensitizer and/or a photoinitiator.

The polymer may comprise sulfur. Sulfur-containing polymers may provide coatings with high refractive indices and may be suitable for applications requiring index matching of coatings with high index substrates. In one embodiment, one of the monomers of the coating composition contains sulfur. In another embodiment, two of the monomers of the coating composition contain sulfur. In still another embodiment, the sulfur present in one or more monomers of the coating composition is present in a reactive functional group. The reactive functional group may be a thiol group or an episulfide group. The one or more monomers may include a monomer with a thiol group and a monomer with an episulfide group. The one or more monomers may each include two or more functional groups. At least one of the two or more functional groups may include sulfur. In one embodiment, the one or more monomers include a monomer with two thiol groups, or two episulfide groups, or one thiol group and one episulfide group.

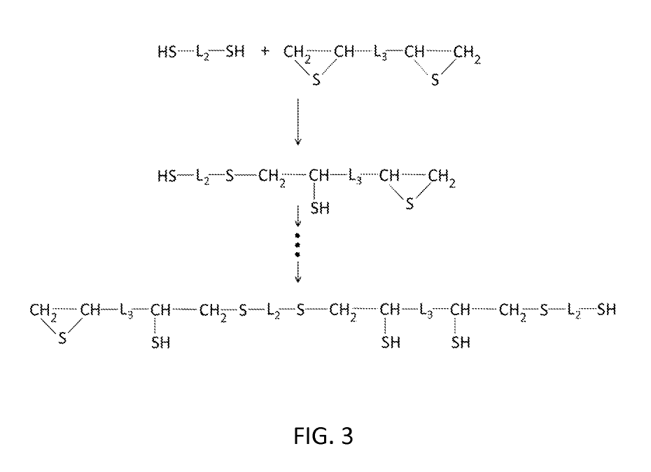

FIG. 3 shows one embodiment of a reaction between two sulfur-containing monomers to form a sulfur-containing polymer coating. One monomer is a dithiol, which includes two thiol functional groups. The second monomer is a bifunctional episulfide monomer, which includes two episulfide functional groups. L₂ and L₃ are organic groups that link the functional groups of each monomer. Thiol groups react with episulfide groups to induce a ring opening reaction of the episulfide group to form a new chemical bond. The bifunctional nature of each monomer permits the growth of extended chains (oligomers) and ultimately polymers. Analogous reactions occur between thiol functional groups and epoxy functional groups, between alcohol functional groups and episulfide functional groups, and between alcohol functional groups and epoxy functional groups.

Reactions thiol or alcohol groups with episulfide or epoxy groups are nucleophilic in nature. The thiol or alcohol group is a nucleophile and reacts with a carbon of the episulfide or epoxy group to initiate the ring opening reaction. The reaction is catalyzed by substances that increase the nucleophilic strength of the thiol or alcohol group. Bases are effective catalysts because they act to deprotonate thiol and alcohol groups to leave negatively charged sulfur and oxygen atoms. The negatively charged sulfur and oxygen atoms are strong nucleophiles and readily react with episulfide and epoxy groups to induce opening of the three-membered ring and formation of a bond between sulfur or oxygen and a carbon of the three-membered ring.

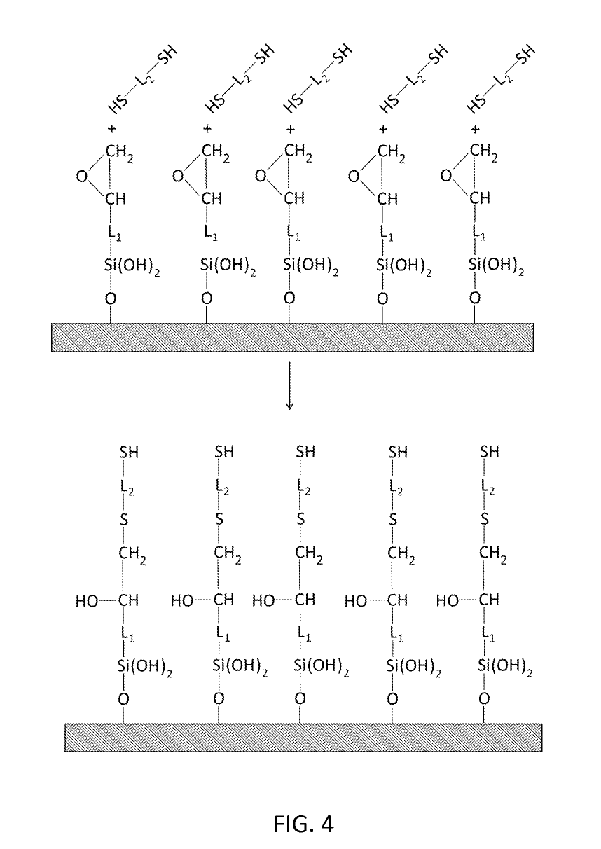

When a coating composition containing a thiol monomer is contacted with an epoxy-functionalized primer layer, the thiol group can react with the epoxy group to induce a ring-opening reaction of the type shown in FIG. 3. FIG. 4 illustrates one embodiment of a reaction of a bifunctional thiol monomer with the epoxy-functionalized primer layer shown in FIG. 2. In this embodiment, the thiol monomer reacts directly with epoxy functional groups of the primer layer to produce a modified primer layer having terminal thiol groups. The terminal thiol groups become sites of reactivity for episulfide and epoxy groups as reaction of the components of the coating composition continues in the formation of the polymer coating. The terminal thiol groups on the primer layer provide bonding sites for the coating and enable chemical attachment of the coating with the substrate via the primer layer.

In addition to thiol monomers, thiol-containing oligomers and polymers that form during reaction of the coating composition may also react with epoxy groups on the surface of the primer layer to facilitate chemical attachment of the coating to the substrate via the primer layer. In practice, a combination of thiol monomers, thiol-containing oligomers, and thiol-functionalized polymers will react with epoxy groups of the primer layer to provide surface functional groups capable of becoming integrated in the polymer coating, thereby providing points of chemical bonding of the polymer coating with the primer layer and insuring good adhesion of the coating with the substrate via the primer layer.

As indicated herein above, in addition to surface functional groups capable of reacting with one or more components of the coating composition, the primer layer may also include a base. The base may be a separate component contained within or on the primer layer. The base may, for example, be dissolved in, embedded in, or adsorbed onto the primer layer. The base may be incorporated in an unreacted form in the primer layer. When a base is present in the primer layer, it becomes available to interact with components of the coating composition during the coating formation reaction. Upon application of the coating composition to the primer layer, the base may be released from the primer layer and participate in reactions with components of the coating composition. As indicated hereinabove, if the coating composition includes thiol groups, bases may act as a catalyst through deprotonation reactions that form negatively charged sulfur groups that act as strong nucleophiles in ring-opening reactions of epoxy groups. Such catalytic effect promotes conversion of epoxy groups of the primer layer to terminal thiol groups via the reaction shown in FIG. 4. The base may also catalyze reactions of thiol monomers with episulfide monomers in the coating composition independent of or in concert with reactions at the surface of the primer layer.

In addition to one or more monomers, the coating composition may also include a photosensitizer and/or photoinitiator. The photosensitizer and/or photoinitiator may facilitate reaction of one or more components of the coating composition.

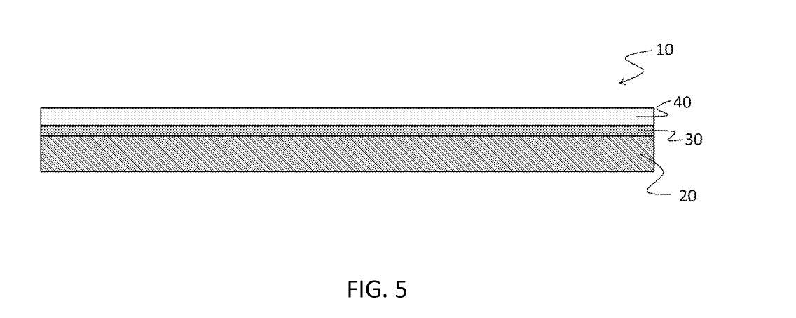

FIG. 5 shows the overall structure of the article. Article 10 includes substrate 20, primer layer 30, and coating 40. Primer layer 30 is bonded to substrate 20 at the interface of primer layer 30 with substrate 20. Primer layer 30 is bonded to coating 40 at the interface of primer layer 30 with coating 40. Although no limitations on the thicknesses of substrate 20, primer layer 30, and coating 40 are contemplated, in certain applications, primer layer 30 may be thinner than coating 40 and coating 40 may be thinner than substrate 20. In one embodiment, primer layer 30 is a monolayer of adhesion promoter molecules (modified as described herein to form chemical bonds with substrate 20 and coating 40). The chemical bonding of primer layer 30 with substrate 20 may include a link of the type M₂-O-M₁, where M₁ is an element of the primer layer and M₂ is an element of the substrate. M₁ and M₂ may independently be Si, a transition metal or a post-transition metal. The chemical bond of the primer layer with the coating may include S or a S—C (sulfur-carbon) bond, where S is an element of the coating and C is an element of the primer layer.

The chemical bond of the primer layer with the coating may include a link of the type:

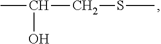

where S is an element of the coating, or where S is an element of the coating and the two carbons are elements of the primer layer, or where S is an element of the coating and O is an element of the primer layer.

The chemical bond of the primer layer with the coating may include a link of the type:

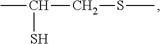

where the S bonded to the CH₂ group is an element of the coating, or where the S bonded to the CH₂ group is an element of the coating and the two carbons are elements of the primer layer, or where the S bonded to the CH₂ group is an element of the coating and the S bonded to the CH group is an element of the primer layer

The chemical bond of the primer layer with the coating may more generally be expressed:

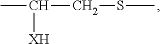

where S is an element of the coating, or where S is an element of the coating and the two carbons are elements of the primer layer, or where S is an element of the coating and X is an element of the primer layer and X is O or S.

The present description includes methods of making articles. The methods include applying a primer composition to a substrate, forming a primer layer from the primer composition, applying a coating composition to the primer layer, and forming a coating from the coating composition.

### Example

This example describes a glass article with a primer layer derived from an epoxy-functionalized silane adhesion promoter, and a coating made from a coating composition that includes a bifunctional thiol monomer and a bifunctional episulfide monomer.

The glass substrate was a high index glass available from Corning SAS under the designation 1.7/35 (code 70035). The primary components of the glass were SiO₂, TiO₂, BaO, and ZrO₂. The glass included lesser amounts of other metal oxides. The glass had an index of refraction of 1.70 at 587.6 nm. The glass substrate was round with a 70 mm diameter and a thickness of 1.94 mm. The glass was subjected to UV/ozone treatment for 10 min before use.

The primer composition was a solution that contained 0.8 g of an epoxy-functionalized silane adhesion promoter, 54, of 1,8-Diazabicycloundec-7-ene (DBU), and 54, of bis-(2-dimethylaminoethyl)ether in 17.2 g ethanol. The epoxy-functionalized adhesion promoter was 3-glycidoxypropyltrimethoxysilane, which has the structure:

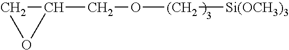

The primer composition was placed in a vial and shaken to homogenize prior to use.

The coating composition included 10 g of LumipluS LPB-1102, 0.1 g photoinitiator (butyltri-1-naphthalenylborate N,N,N-tributyl-1-butanaminium (CAS 219125-19-6), available from Showa Denko KK), 0.1 g photosensitizer (4-(4-methylphenylthio)benzophenone (CAS 83846-85-9), available from Nippon Kayaku), and 5 μL of a wetting agent (Byk 333, a polyether modified polydimethylsiloxane available from BYK Additives & Instruments (Wallingford, Conn.)). LumipluS LPB-1102 (available from Mitsubishi Gas Chemical) is a mix of bis(2,3-epithiopropyl) disulfide (CAS 98485-71-3) and 2,2′-thiodiethanethiol (CAS 3570-55-6). Bis(2,3-epithiopropyl) disulfide has the structure:

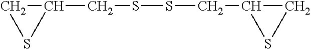

and 2,2′-thiodiethanethiol has the structure:

HS—CH₂—CH₂—S—CH₂—CH₂—SH

Articles were fabricated by applying the primer composition and coating composition to the glass substrate. The primer composition was applied by spin coating an aliquot of primer composition on the glass substrate at 2000 rpm for 10 sec and allowing the glass substrate to dry over night at room temperature to form a primer layer. The coating composition was applied to the primer layer by one of two methods. In one method, the coating composition was applied by spin coating an aliquot of coating composition on the primer layer at 2000 rpm for 10 sec. The sample was then cured with UV light in an N₂ atmosphere for one minute. The UV exposure was provided by a Lesco Super Max HP source that was positioned 50 mm from the sample and operated at 100% power. The UV-cured sample was then heated at 150° C. for one hour. In the second method, a 5 μL droplet of the coating composition was pipetted onto the center of the primer layer. The droplet was covered with a Teflon plastic sheet (˜50 mm×˜50 mm×˜11 mm thick) to spread the droplet. Light compression was applied to the plastic sheet to spread the dropout to a diameter of ˜50 mm and a thickness of ˜2.5 μm. While compression was maintained, the spread droplet was subjected to UV curing with the Lesco Super Max HP source through the glass substrate. The Lesco Super Max HP source that was positioned below the glass substrate at a distance of ˜50 mm from the spread droplet and was operated at 100% power. Compression was released, the plastic sheet was removed and the UV-cured sample was then heated at 150° C. for one hour.

The strength of adhesion of the cured coating to the glass substrate was tested using crosshatch adhesion test specified in the ASTM D3359-97 standard (“Standard Test Methods for Measuring Adhesion by Tape Test”). A summary description of the crosshatch adhesion test follows. A series of cuts in a crosshatch configuration are made in an unblemished section of the coating. The cuts extended through the coating to the substrate and segmented the coating. Detached flakes were removed with a soft brush. Pressure-sensitive tape was applied over the crosshatch cut and was smoothed into place by pressing with a pencil eraser. The tape was removed by pulling it rapidly back over itself at an angle as close to 180° as possible. An article is deemed to pass the test if none of the coating is removed when the tape is pulled. Articles prepared using both methods of applying the coating composition passed the crosshatch adhesion test. Control articles were prepared with the same coating without the primer layer and were shown to fail the crosshatch adhesion test.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the illustrated embodiments. Since modifications, combinations, sub-combinations and variations of the disclosed embodiments that incorporate the spirit and substance of the illustrated embodiments may occur to persons skilled in the art, the description should be construed to include everything within the scope of the appended claims and their equivalents.

What is claimed is:

1. An article comprising:
a substrate, said substrate comprising an element M₂;
a primer layer on said substrate, said primer layer comprising an element M₁ and an element X, said primer layer being chemically bonded to said substrate through a first chemical linkage, said first chemical linkage comprising said element M₁, said element M₂, and oxygen, said first chemical linkage having the form M₁-O-M₂; and
a coating comprising sulfur on said primer layer, said coating being chemically bonded to said primer layer through a second chemical linkage, said second chemical linkage comprising said sulfur and said element X, said second chemical linkage having the form 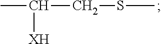
wherein said element X is O or S.

2. The article of claim 1, wherein said substrate comprises a glass or ceramic.

3. The article of claim 1, wherein said element M₂ is Si.

4. The article of claim 1, wherein said element M₂ is a transition metal.

5. The article of claim 1, wherein said element M₁ and said element X are bonded through a third chemical linkage, said third chemical linkage comprising an alkylene group or an ether group.

6. The article of claim 1, wherein said substrate comprises glass, said element M₂ is Si, said element M₁ is Si, and said element X is O.

7. The article of claim 1, wherein said second chemical linkage is the product of a reaction between an epoxy or episulfide group and a thiol group.

8. The article of claim 1, wherein said primer layer further comprises a base.

9. The article of claim 1, wherein said coating comprises a polymer, said polymer comprising said sulfur.

10. The article of claim 9, wherein said polymer is a copolymer of a first monomer and a second monomer, said first monomer comprising said sulfur.

11. The article of claim 10, wherein said second monomer comprises sulfur.

12. The article of claim 1, wherein said coating has a refractive index of at least 1.6.

13. The article of claim 12, wherein said substrate has a refractive index of at least 1.6.

14. A primer composition comprising:
an adhesion promoter, said adhesion promoter including a central atom, a first functional group chemically linked to said central atom, and a second functional group chemically linked to said central atom; and
a catalyst.

15. The primer composition of claim 14, wherein said central atom is Si or a transition metal, said first functional group is a hydroxyl group or an alkoxy group, said second functional group is an epoxy or episulfide group, and said catalyst is a base.

16. The primer composition of claim 15, further comprising a solvent selected from the group consisting of alcohols, ketones, esters, ethers and aromatics.

17. The primer composition of claim 16, wherein the concentration of said adhesion promoter is in the range from 0.10 wt % to 10 wt % and the concentration of said base is in the range from 0.001 wt % to 0.3 wt %.

18. The primer composition of claim 15, wherein said base is selected from the group consisting of 1,8-Diazabicyclo[5.4.0]undec-7-ene (DBU), 1,5-Diazabicyclo[4.3.0]non-5-ene (DBN), 1,4-Diazabicyclo[2.2.2]octane (DABCO), 7-methyl-1,5,7-triazabicyclo[4.4.0]dec-5-ene (MTBD), 1,5,7-triazabicyclo[4.4.0]dec-5-ene (TBD), tetramethylguanidine (TMG), N-methylmorpholine, N-ethylmorpholine, dimethylpiperazine, N,N-Dimethylcyclohexylamine (DMCHA), pentamethyldiethylenetriamine (PMDETA), tetramethylbis(aminoethyl)ether (ZF-20), DMDGA™ N,N-dimethyl-2(2-aminoethoxy)ethanol (ZR-70), pentamethyldipropylenetriamine (ZR-40), tetramethyldipropylenetriamine (ZR-50B), and benzyldimethylamine (BDMA).

19. A method of coating comprising:
forming a primer layer on a substrate, said substrate comprising an element M₂ and oxygen, said forming primer layer comprising applying a primer composition to said substrate, said primer composition comprising an adhesion promoter, said adhesion promoter having a central element M₁ consisting of Si or a transition metal, a first functional group, and a second functional group, said first functional group reacting with said substrate to form a chemical link between said adhesion promoter and said substrate; and
forming a coating on said primer layer, said forming coating comprising applying a coating composition to said primer layer, said coating composition comprising a first functional group containing sulfur, said first functional group containing sulfur reacting with said second functional group of said adhesion promoter to form a chemical link between said primer layer and said coating.

20. The method of claim 19, wherein said primary composition further comprises a base.

21. The method of claim 20, wherein said base catalyzes said reaction of said first functional group with said substrate.

22. The method of claim 20, wherein said base is incorporated in said primer layer in an unreacted form.

23. The method of claim 20, wherein said base catalyzes said reaction of said second functional group with said first functional group containing sulfur.

24. The method of claim 19, wherein said coating composition comprises a first monomer and a second monomer, said first monomer comprising said first sulfur-containing functional group, said forming coating comprising a reaction between said first monomer and said second monomer.

25. The method of claim 24, wherein said second monomer comprises a second sulfur-containing functional group.

26. The method of claim 19, wherein said coating composition further comprises a photoinitiator.
